(19) United States
(12) Patent Application Publication
(10) Pub. No.: US 2025/0024122 A1
(43) Pub. Date: Jan. 16, 2025

(54) METHOD, SYSTEM AND NON-TRANSITORY COMPUTER-READABLE RECORDING MEDIUM FOR PROVIDING INTERACTIVE CONTENTS

(71) Applicant: GENESIS LAB, INC., Seoul (KR)

(72) Inventors: Young Bok LEE, Seoul (KR); Dae Hun YOO, Seoul (KR)

(73) Assignee: GENESIS LAB, INC., Seoul (KR)

(21) Appl. No.: 18/710,663

(22) PCT Filed: Nov. 16, 2022
(86) PCT No.: PCT/KR2022/018135

§ 371 Date: May 16, 2024

(30) Foreign Application Priority Data
Nov. 17, 2021 (KR) 10-2021-0158110

(51) Int. Cl. H04N 21/8545; H04N 21/8541

(52) U.S. Cl. CPC H04N 21/8545; H04N 21/8541

(57) ABSTRACT

A method for providing interactive contents is provided. The method includes the steps of: acquiring interactive data of a first user participating in an interactive content in which at least one unit content is provided according to a condition in at least one branch; and determining information on progress of an interactive content in which a second user associated with the first user participates, with reference to the interactive data of the first user.

### FIELD OF THE INVENTION

The present invention relates to a method, system, and non-transitory computer-readable recording medium for providing interactive contents.

### BACKGROUND

With the development of digital technology in the 21st century, the expansion of virtual worlds has broaden online interactions and enabled online experiences of narrative works, and the rise of hypertext narrative works has led to the development of entertainment such as online fiction, online games, online comedy, and digital device art.

Along with the above development, the way of communication in the modern digital media environment has diversified from the one-way content injection method of the past to the novel two-way communication method of the new media era, and interactive contents such as interactive movies or interactive webtoons have attracted the interest of many users because the course of the contents changes depending on the users' participation, so that the development thereof is expected.

However, according to the techniques introduced so far as well as the above conventional techniques, even if a user participating in an interactive content makes a choice (or performs an action) in a particular branch, the choice (or action) only affects the interactive content in which the user participates, and cannot affect an interactive content in which another user participates. This limits the ability of multiple users to experience an interactive content together.

In this connection, the inventor(s) present a novel and inventive technique capable of influencing progress of an interactive content in which a user participates, on the basis of interactive data (e.g., body part size or shape, emotion, facial expression, and movement) of another user participating in an interactive content.

### SUMMARY OF THE INVENTION

An object of the present invention is to solve all the above-described problems in the prior art.

An object of the invention is to enable immersive progress of contents on the basis of interactions between a plurality of users by influencing progress of an interactive content in which a second user participates with reference to interactive data of a first user participating in an interactive content.

An object of the invention is to make progress of an interactive content less predictable and increase enjoyment and interest of users by determining progress of an interactive content in which a second user participates (e.g., determining a unit content to be provided in at least one branch) according to interactive data of a first user (e.g., the interactive data may be managed continuously and cumulatively).

An object of the invention is to induce user participation in an interactive content by allowing progress of the interactive content to vary on the basis of the number of users participating in the interactive content (e.g., by varying unit contents that may be provided on the basis of the number of users).

An object of the invention is to enhance experience (e.g., manipulation experience) of each user participating in an interactive content by allowing an action of an object appearing in the interactive content (or a unit content associated with the object) to be determined on the basis of interactive data of the user.

The representative configurations of the invention to achieve the above objects are described below.

According to one aspect of the invention, there is provided a method for providing interactive contents, the method comprising the steps of: acquiring interactive data of a first user participating in an interactive content in which at least one unit content is provided according to a condition in at least one branch; and determining information on progress of an interactive content in which a second user associated with the first user participates, with reference to the interactive data of the first user.

According to another aspect of the invention, there is provided a system for providing interactive contents, the system comprising: a data acquisition unit configured to acquire interactive data of a first user participating in an interactive content in which at least one unit content is provided according to a condition in at least one branch; and an information determination unit configured to determine information on progress of an interactive content in which a second user associated with the first user participates, with reference to the interactive data of the first user.

In addition, there are further provided other methods and systems to implement the invention, as well as non-transitory computer-readable recording media having stored thereon computer programs for executing the methods.

According to the invention, it is possible to enable immersive progress of contents on the basis of interactions between a plurality of users by influencing progress of an interactive content in which a second user participates with reference to interactive data of a first user participating in an interactive content.

According to the invention, it is possible to make progress of an interactive content less predictable and increase enjoyment and interest of users by determining progress of an interactive content in which a second user participates (e.g., determining a unit content to be provided in at least one branch) according to interactive data of a first user (e.g., the interactive data may be managed continuously and cumulatively).

According to the invention, it is possible to induce user participation in an interactive content by allowing progress of the interactive content to vary on the basis of the number of users participating in the interactive content (e.g., by varying unit contents that may be provided on the basis of the number of users).

According to the invention, it is possible to enhance experience (e.g., manipulation experience) of each user participating in an interactive content by allowing an action of an object appearing in the interactive content (or a unit content associated with the object) to be determined on the basis of interactive data of the user.

### BRIEF DESCRIPTION OF THE DRAWINGS

FIG. 1 schematically shows the configuration of an entire system for providing interactive contents according to one embodiment of the invention.

FIG. 2 illustratively shows the internal configuration of an interactive content provision system according to one embodiment of the invention.

FIG. 3 illustratively shows a situation in which information on progress of an interactive content provided to a user is determined on the basis of another user's interactive data according to one embodiment of the invention.

FIG. 4 illustratively shows a situation in which information on progress of an interactive content provided to a user is determined on the basis of another user's interactive data according to one embodiment of the invention.

FIG. 5 illustratively shows a situation in which information on progress of an interactive content provided to a user is determined on the basis of another user's interactive data according to one embodiment of the invention.

FIG. 6 illustratively shows another situation in which information on progress of an interactive content provided to a user is determined on the basis of another user's interactive data according to one embodiment of the invention.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

In addition, the terms containing ordinal numbers such as “first” and “second” may be used to describe various components, but the components are not limited by such terms. These terms are used only to distinguish one component from another. For example, without departing from the scope of the invention, a first component may be named a second component, and likewise a second component may be named a first component.

Herein, the term “content” or “contents” encompasses digital information or individual information elements comprised of text, symbol, speech, sound, image, video, and the like, which are accessible via communication networks. For example, such contents may comprise data such as text, image, video, audio, and links (e.g., web links) or a combination of at least two types of such data.

Further, an interactive content herein may refer to a content whose development, course, or flow (e.g., background, location, characters (e.g., clothing, props, and dispositions thereof), and ending) may be determined on the basis of a user's interactive data. For example, the interactive content may comprise at least one branch and at least one unit content provided in the at least one branch, and when a specific condition (e.g., the specific condition may be preset or dynamically set, and may be associated with the user's interactive data) is satisfied in the at least one branch, at least one unit content associated with the condition may be provided. Here, a unit content may refer to a minimum unit of content that is unbranched with respect to the development, course, or flow of the content. Further, each unit content may be connected to each other around (or through) the at least one branch.

In addition, interactive data herein may be acquired from a user participating in an interactive content, and the interactive data according to the invention may include any object that may be recognized with respect to the user (e.g., a video of the user), such as a shape, speech, facial expression, emotion, and movement. For example, the interactive data may be acquired from a video (possibly containing speech) of the user participating in the interactive content (e.g., interaction video).

Hereinafter, various preferred embodiments of the invention will be described in detail with reference to the accompanying drawings to enable those skilled in the art to easily implement the invention.

### Configuration of the Entire System

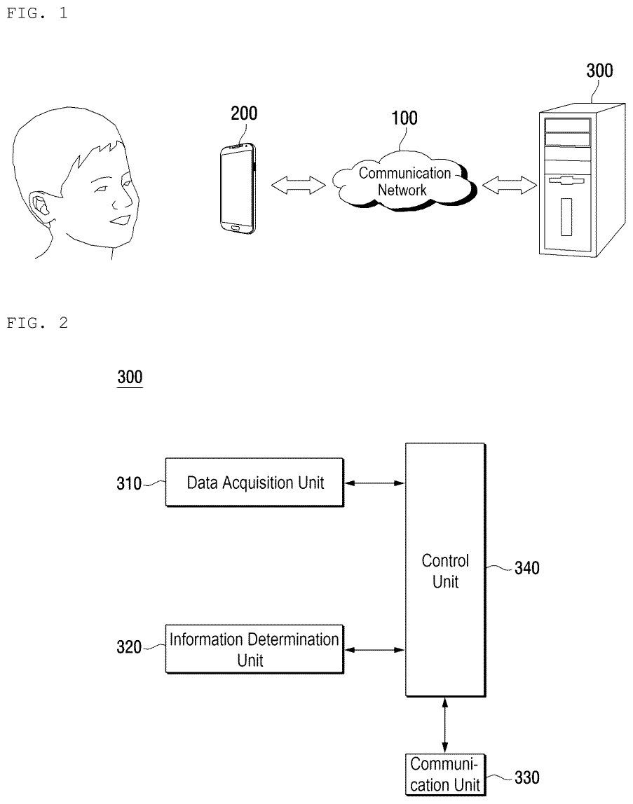

FIG. 1 schematically shows the configuration of the entire system for providing interactive contents according to one embodiment of the invention.

As shown in FIG. 1, the entire system according to one embodiment of the invention may comprise a communication network 100, a device 200, and an interactive content provision system 300.

First, the communication network 100 according to one embodiment of the invention may be implemented regardless of communication modality as such wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, Bluetooth communication (including Bluetooth Low Energy (BLE) communication), infrared communication, and ultrasonic communication.

Next, the device 200 according to one embodiment of the invention is digital equipment capable of connecting to and then communicating with the interactive content provision system 300 to be described below via the communication network 100, and any type of digital equipment having a memory means and a microprocessor for computing capabilities, such as a computer, a laptop, a smart phone, and a tablet PC, may be adopted as the device 200 according to the invention.

Meanwhile, the device 200 may include an application for supporting the provision of interactive contents according to the invention. The application may be downloaded from an external application distribution server (not shown). Meanwhile, the characteristics of the application may be generally similar to those of a data acquisition unit 310, an information determination unit 320, a communication unit 330, and a control unit 340 of the interactive content provision system 300 to be described below. Here, at least a part of the application may be replaced with a hardware device or a firmware device that may perform a substantially equal or equivalent function, as necessary.

Next, the interactive content provision system 300 according to one embodiment of the invention may communicate with the device 200 via the communication network 100, and may function to acquire interactive data of a first user participating in an interactive content in which at least one unit content is provided according to a condition in at least one branch, and determine information on progress of an interactive content in which a second user associated with the first user participates, with reference to the interactive data of the first user.

Further, the interactive content according to one embodiment of the invention may have a multi-ending structure. In order to realize multiple endings, the interactive content may comprise at least one branch (wherein a condition may be set for the branch and associated with user interactive data) and a plurality of unit contents to be provided in the at least one branch (wherein the unit contents may include storytelling elements).

More specifically, the interactive content having a multi-ending structure may be organized (e.g., organized similarly to a content franchise) using a plurality of contents per genre (e.g., romance, horror, psychological, or action) of a web drama production company. In this case, the user understands the narrative as an extension of the original narrative, so that the user may have prior information on spaces, characters, situations, and the like, and thus the user's immersion is enhanced.

Meanwhile, the interactive content according to the invention is not necessarily limited to a storytelling content (or a multi-ending structured content), and may be changed to contents with various structures such as a game content, a loop content (e.g., repetitive dance training), and a counseling or therapy content (e.g., a healthcare counseling and therapy content) as long as the objects of the invention may be achieved.

For example, the interactive content according to one embodiment of the invention may be a game content that induces participation of a plurality of users (specifically, a first user and a second user) through competition. More specifically, in a case where the interactive content according to one embodiment of the invention is a content about an acronym quiz game, if a unit content about a question is provided and interactive data of the first user and the second user (e.g., stating that (or making a facial expression that) the user does not know the correct answer) are acquired with respect to a branch temporally adjacent to the unit content (e.g., when the branch is reached or while a unit content adjacent to the branch (e.g., an immediately preceding unit content) is provided), a unit content for assisting the first user and the second user in solving the question (e.g., a unit content about a hint for the question) may be provided according to a condition set for the branch (i.e., when a situation occurs in which both the first user and the second user do not know the correct answer). Here, the unit content for assisting in solving the question may not be provided in the above branch unless neither the first user nor the second user knows the correct answer (i.e., any one of the first user and the second user does not know the correct answer).

The configuration and functions of the interactive content provision system 300 according to the invention will be discussed in more detail below. Meanwhile, the above description is illustrative although the interactive content provision system 300 has been described as above, and it is apparent to those skilled in the art that at least a part of the functions or components required for the interactive content provision system 300 may be implemented in the device 200 or a server (not shown) or included in an external system (not shown), as necessary. Further, in some cases, all of the functions and components of the interactive content provision system 300 may be implemented or included in the device 200.

### Configuration of the Interactive Content Provision System

Hereinafter, the internal configuration of the interactive content provision system 300 crucial for implementing the invention and the functions of the respective components thereof will be discussed.

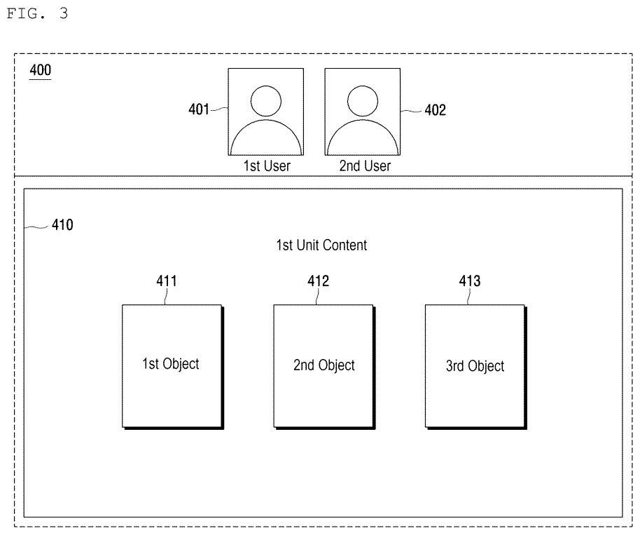

FIG. 2 illustratively shows the internal configuration of the interactive content provision system 300 according to one embodiment of the invention.

As shown in FIG. 2, the interactive content provision system 300 according to one embodiment of the invention may comprise a data acquisition unit 310, an information determination unit 320, a communication unit 330, and a control unit 340. According to one embodiment of the invention, at least some of the data acquisition unit 310, the information determination unit 320, the communication unit 330, and the control unit 340 may be program modules to communicate with an external system (not shown). The program modules may be included in the interactive content provision system 300 in the form of operating systems, application program modules, and other program modules, while they may be physically stored in a variety of commonly known storage devices. Further, the program modules may also be stored in a remote storage device that may communicate with the interactive content provision system 300. Meanwhile, such program modules may include, but are not limited to, routines, subroutines, programs, objects, components, data structures, and the like for performing specific tasks or executing specific abstract data types as will be described below in accordance with the invention.

First, the data acquisition unit 310 according to one embodiment of the invention may acquire interactive data of a user participating in an interactive content in which at least one unit content is provided according to a condition in at least one branch.

For example, the data acquisition unit 310 may acquire interactive data of a user participating in an interactive content by analyzing a video of the user (e.g., a video of the user's interaction that is acquired with respect to at least one branch in the interactive content).

More specifically, the data acquisition unit 310 may acquire interactive data of a user participating in an interactive content by analyzing a video of the user's interaction that is acquired at a time when a specific unit content is finished being provided to the user (or when a branch connected with the unit content is reached) or acquired while a unit content adjacent to the branch (e.g., an immediately preceding unit content with respect to the branch) is provided to the user. Meanwhile, the time when the interactive data according to the invention is acquired is not necessarily limited to those listed above, and may be diversely changed as long as the objects of the invention may be achieved.

Further, the data acquisition unit 310 according to one embodiment of the invention may use at least one trained feature extraction model (e.g., trained with machine learning on the basis of a plurality of videos and feature information extracted from the plurality of videos) to extract feature information on speech, image, or text from a video of a user participating in an interactive content, and may acquire interactive data of the user on the basis of the feature information. The feature extraction model may be implemented on the basis of various artificial intelligence models such as a convolutional neural network (CNN), a recurrent neural network (RNN), and a long short-term model (LSTM). Meanwhile, the feature extraction model according to one embodiment of the invention is not necessarily limited to artificial intelligence models used for image analysis, and may be diversely changed as long as the objects of the invention may be achieved.

For example, the data acquisition unit 310 may input image information, which is specified by segmenting a video of the user (e.g., a video of the user's interaction) into predetermined time intervals, to a CNN and input image feature information derived from the CNN to a RNN (or LSTM) in a time series to derive detailed image feature information, may input speech information obtained by segmenting speech contained in the user's video into predetermined time intervals (e.g., the speech itself or a pitch, intensity, MFCC, and the like of the speech) to a CNN and input speech feature information derived from the CNN to a RNN (or LSTM) in a time series to derive detailed speech feature information, and may input a vector in which text contained in the user's video is embedded by tokens to a RNN (or LSTM) in a time series to derive detailed text feature information, thereby acquiring interactive data of the user with reference to at least one of the detailed image feature information, the detailed speech feature information, and the detailed text feature information derived above. Meanwhile, the feature information extracted from the user's video according to one embodiment of the invention is not necessarily limited to those listed above, and the types and number of pieces thereof may be diversely changed as long as the objects of the invention may be achieved (e.g., it is possible to only derive detailed feature information on one of speech and image, or to further derive detailed feature information on other objects than speech, image, and text).

Next, the information determination unit 320 according to one embodiment of the invention may function to determine information on progress of an interactive content in which a second user associated with the first user participates, with reference to the interactive data of the first user acquired by the data acquisition unit 310. Here, the second user according to one embodiment of the invention may be a user having a predetermined relationship with the first user. For example, the second user may be a user who is provided with (or who also participates in) the interactive content in which the first user participates. As another example, the second user may be a user who has an online or offline relationship with the first user (e.g., a friend on a social network service (SNS)). As another example, the first user and the second user may be users who belong to the same group or groups that are associated with each other. The relationship between the users according to the invention is not necessarily limited to those listed above, and may be diversely changed as long as the objects of the invention may be achieved. Further, the information on the progress of the interactive content according to one embodiment of the invention may include information on which of a plurality of unit contents that may be provided in a branch is to be provided, components of the unit content to be provided (e.g., characters and objects appearing in the unit content), attributes of the unit content to be provided (e.g., facial expressions, appearances, and dispositions of the characters, sizes of the objects, background (or weather), location, music, and dialogue), and the like. The information on the progress of the content according to one embodiment of the invention is not necessarily limited to those listed above, and may include any information related to development, course, flow, and the like of the content as long as the objects of the invention may be achieved.

For example, the information determination unit 320 may determine a unit content to be provided in at least one branch of the interactive content in which the second user associated with the first user participates, with reference to the interactive data of the first user.

More specifically, when the interactive content in which the first user participates and the interactive content in which the second user participates contain the same character, and the character dies in the interactive content in which the first user participates on the basis of the first user's interactive data, the information determination unit 320 may determine a unit content in which the character does not appear, among a plurality of unit contents that may be provided in at least one branch of the interactive content in which the second user participates, as the unit content to be provided to the second user. Further, when the interactive content in which the first user participates and the interactive content in which the second user participates contain the same character, and the character gets married in the interactive content in which the first user participates on the basis of the first user's interactive data, the information determination unit 320 may add a wedding photograph (or a bright background and music) to each of a plurality of unit contents that may be provided in at least one branch of the interactive content in which the second user participates, thereby determining a unit content that contains the wedding photograph (or the bright background and music) as the unit content to be provided to the second user.

Further, when first interactive data by the first user is acquired, the information determination unit 320 may determine a unit content that corresponds to a branching condition satisfied by the first interactive data, among a plurality of unit contents that may be provided in at least one branch of the interactive content in which the second user participates (wherein the branching condition set for the at least one branch may be associated with the first user's interactive data), as the unit content to be provided to the second user.

For example, when a condition of a specific branch of the interactive content in which the second user participates is that the second user is provided with a first unit content if the first interactive data by the first user is generated, and otherwise provided with a second unit content, the information determination unit 320 may determine the first unit content corresponding to the condition of the branch as the unit content to be provided to the second user if the first interactive data by the first user is acquired.

Further, the information determination unit 320 may determine a unit content that is similar to situation information (or context information) specified on the basis of the first user's interactive data at or above a predetermined level, among situation information (or context information) specified from each of a plurality of unit contents that may be provided in at least one branch of the interactive content in which the second user participates (wherein the branching condition for the at least one branch may be that a unit content is provided having situation information (or context information) similar to situation information (or context information) specified on the basis of the first user's interactive data at or above a predetermined level), as a unit content to be provided in at least one branch of the interactive content in which the second user participates.

Meanwhile, the information determination unit 320 according to one embodiment of the invention may determine situation information (or context information) specified from a unit content with reference to a database or lookup table (not shown) for situation information (or context information) corresponding to components or attributes of the unit content (e.g., characters, background, and scenario). Further, the database or lookup table may be preset or dynamically set.

Meanwhile, it is noted that the plurality of unit contents that may be provided in at least one branch according to one embodiment of the invention are not necessarily limited to being preset, and may be diversely changed (e.g., may be generated in real time with reference to at least one unit content (or components thereof) preceding the branch, the user's interactive data, and the like) as long as the objects of the invention may be achieved.

Further, the information determination unit 320 may cause a first object among objects of the interactive content in which the first user participates to be associated with the first user, and cause a second object among objects of the interactive content in which the second user participates to be associated with the second user. The first object and the second object may be the same or different.

For example, the information determination unit 320 may cause an action of the first object (or a unit content associated with the first object) of the interactive content in which the first user participates to be determined on the basis of the first user's interactive data, and cause an action of the second object (or a unit content associated with the second object) of the interactive content in which the second user participates to be determined on the basis of the second user's interactive data.

More specifically, when a first object among objects appearing in an interactive content about a competitive game in which the first user and the second user participate together is associated with the first user, and a second object among the objects appearing in the interactive content is associated with the second user, the information determination unit 320 may cause a unit content in which the first object performs a predetermined action (e.g., the first object swings a first) to be provided in a specific branch of the interactive content on the basis of the first user's interactive data (e.g., swinging a first) acquired through a video of the first user's interaction. Further, the information determination unit 320 may cause a unit content in which the second object performs a predetermined action (e.g., the second object dodges the first object's first) to be provided in the specific branch of the interactive content on the basis of the second user's interactive data (e.g., moving his/her head) acquired through a video of the second user's interaction.

Further, when a first object among objects appearing in the interactive content in which the first user participates is associated with the first user, and a second object among objects appearing in the interactive content in which the second user participates is associated with the second user, the information determination unit 320 may determine information on progress of the interactive content in which the first user or the second user participates on the basis of a combination of the first object's action and the second object's action.

For example, when an action of the first object (e.g., pulling a first lever) determined on the basis of the first user's interactive data within a time limit in a specific branch of the interactive content in which the first user and the second user participate together, and an action of the second object (e.g., pulling a second lever) determined on the basis of the second user's interactive data within a time limit in the specific branch of the interactive content (e.g., pulling the second lever) satisfy a condition set for the branch of the interactive content (e.g., a condition set on the basis of a combination of the first user's interactive data and the second user's interactive data, or a combination of the first object's action and the second object's action), the information determination unit 320 may determine a unit content corresponding to the condition, among a plurality of unit contents that may be provided in the branch, as a unit content to be provided to the first user or the second user. If the first object or the second object is not associated with a specific user (e.g., if the first object or the second object is a non-player character (NPC) object), the unit content may be a content that cannot be provided to the first user or the second user (e.g., the first object's action may not be performed when the first object is an NPC object).

Further, when a first object among objects appearing in an interactive content in which a first user participates is associated with the first user, a second object among objects appearing in an interactive content in which a second user participates is associated with the second user, and a third object among objects appearing in an interactive content in which a third user participates is associated with the third user, the information determination unit 320 may determine information on progress of the interactive content in which the third user participates on the basis of a combination of the first object's action and the second object's action.

For example, when the third object is put in prison in an interactive content in which the first user, the second user, and the third user participate together, and an action of the first object (e.g., pulling a first lever) determined on the basis of the first user's interactive data within a time limit in a specific branch of the interactive content, and an action of the second object (e.g., pulling a second lever) determined on the basis of the second user's interactive data within a time limit in the specific branch of the interactive content (e.g., pulling the second lever) satisfy a condition set for the branch of the interactive content (e.g., a condition set on the basis of a combination of the first user's interactive data and the second user's interactive data, or a combination of the first object's action and the second object's action), the information determination unit 320 determine a unit content corresponding to the condition (e.g., a content in which the third object breaks out of prison), among a plurality of unit contents that may be provided in the branch, as a unit content to be provided to the third user (or the first user and the second user).

Further, the information determination unit 320 may determine information on progress of the interactive content in which the first user or the second user participates on the basis of the number of users associated with the interactive content.

For example, the information determination unit 320 may determine a first unit content as a unit content to be provided if a condition determined on the basis of interactive data of three or more users is satisfied in a specific branch of the interactive content in which the first user or the second user participates, and otherwise determine a second unit content as a unit content to be provided. When only the first user and the second user participate in the interactive content together, the information determination unit 320 may determine only the second unit content as a unit content to be provided in the branch (i.e., the first unit content may not be provided in the branch).

As another example, according to one embodiment of the invention, when a first unit content may be provided in a specific branch if the number of users participating an interactive content exceeds a preset number, the information determination unit 320 may determine the first unit content as a unit content to be provided in the branch if the number of users participating the interactive content exceeds the preset number.

Meanwhile, the information determination unit 320 according to one embodiment of the invention may cause an object not associated with a specific user, among objects of the interactive content in which the first user or the second user participates, to be controlled as an NPC object.

For example, the information determination unit 320 may cause an object not associated with a specific user, among objects appearing in the interactive content, to be controlled as an NPC object such that the object performs an action in a manner (or algorithm, scenario, or the like) that is preset in correspondence to the interactive content (or unit content thereof). This may allow the interactive content to progress even if the user is unable to participate in all of the objects appearing in the content.

Further, the information determination unit 320 may cause at least one unit content of the interactive content in which the second user participates to be provided to the first user if at least one condition is satisfied in at least one branch of the interactive content in which the first user participates, and cause at least one unit content of the interactive content in which the first user participates to be provided to the second user if at least one condition is satisfied in at least one branch of the interactive content in which the second user participates.

For example, the information determination unit 320 may cause at least one unit content of the interactive content in which the second user participates to be provided to the first user in at least one branch of the interactive content in which the first user participates if the first user's interactive data satisfies at least one condition set for the at least one branch, and cause at least one unit content of the interactive content in which the first user participates to be provided to the second user in at least one branch of the interactive content in which the second user participates if the second user's interactive data satisfies at least one condition set for the at least one branch. Here, the interactive contents in which the first user and the second user respectively participate may be connected with each other with respect to at least one branch, and each user may participate in the interactive content of the other user (or the counterpart): if the interactive data of each user satisfies a condition set for the at least one branch. When the second user participates in a first unit content of the interactive content in which the second user participates at the time the first unit content is provided to the first user, the first user and the second user may meet each other in the first unit content (e.g., when the interactive content in which the first user participates and the interactive content in which the second user participates contain a first object as a common object, and the first user is associated with the first object and the second user is associated with a second object of the interactive content in which the second user participates, the first user and the second user may meet each other in the first unit content as the first object and the second object).

Further, according to one embodiment of the invention, the information determination unit 320 may determine the information on the progress of the interactive content in which the second user participates, with reference to the first user's interactive data that is cumulatively acquired with respect to each of a plurality of branches of the interactive content.

For example, the information determination unit 320 according to one embodiment of the invention may accumulate the first user's interactive data acquired with respect to a first branch of the interactive content, the first user's interactive data acquired with respect to a second branch of the interactive content, and the first user's interactive data acquired with respect to a third branch of the interactive content to acquire the first user's accumulated interactive data, and may determine a unit content to be provided to the second user in at least one branch of the interactive content in which the second user participates, with reference to the first user's accumulated interactive data cumulatively acquired from the plurality of branches.

More specifically, the information determination unit 320 may determine a unit content (e.g., a content about taking quizzes with a difficulty level A higher than B) that is similar to situation information (or context information) (e.g., finding quizzes very easy) specified on the basis of the first user's accumulated interactive data (e.g., data on a confident facial expression due to correctly answering all quizzes with a difficulty level B) at or above a predetermined level, among situation information (or context information) specified from each of a plurality of unit contents that may be provided in at least one branch of an interactive content in which the first user and the second user participate (e.g., an interactive content about taking quizzes), as the unit content to be provided in at least one branch of the interactive content in which the second user participates.

Next, the communication unit 330 according to one embodiment of the invention may function to enable data transmission/reception from/to the data acquisition unit 310 and the information determination unit 320.

Lastly, the control unit 340 according to one embodiment of the invention may function to control data flow among the data acquisition unit 310, the information determination unit 320, and the communication unit 330. That is, the control unit 340 according to the invention may control data flow into/out of the interactive content provision system 300 or data flow among the respective components of the interactive content provision system 300, such that the data acquisition unit 310, the information determination unit 320, and the communication unit 330 may carry out their particular functions, respectively.

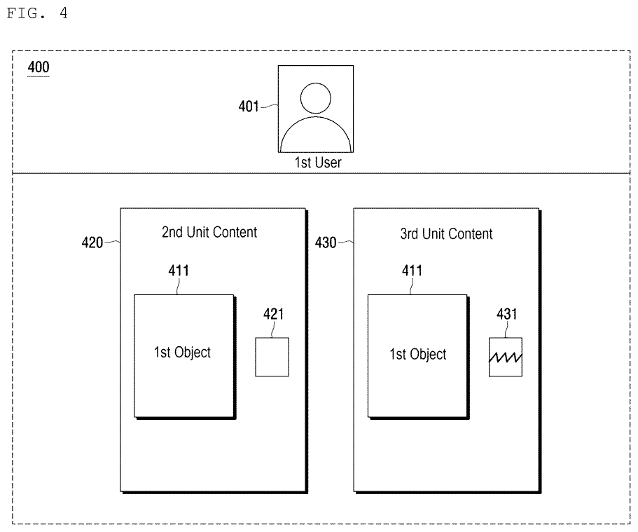

FIGS. 3 to 5 illustratively show a situation in which information on progress of an interactive content provided to a user is determined on the basis of another user's interactive data according to one embodiment of the invention.

According to one embodiment of the invention, a situation may be assumed in which a first user 401 and a second user 402 participate in the same interactive content 400 (i.e., a single interactive content) at different times.

First, referring to FIG. 3, a first unit content 410 about selecting a character from the interactive content 400 according to one embodiment of the invention may be provided to the first user 401 and the second user 402. The interactive content 400 may contain n three characters (hereinafter referred to as a first object 411, a second object 412, and a third object 413), and the first user 401 may be associated with the first object 411 and the second user 402 may be associated with the second object 412. Meanwhile, the third object 413 that is not associated with a user participating in the interactive content 400 may be an NPC object that may be controlled in a preset manner (or algorithm, scenario, or the like) in the interactive content or unit content thereof.

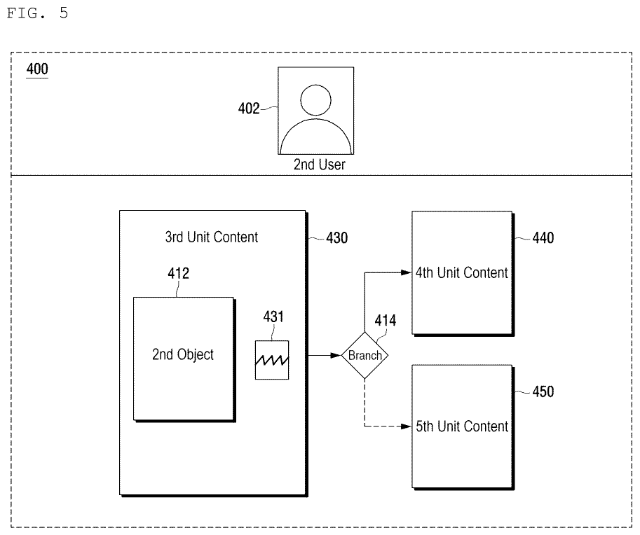

Next, referring to FIG. 4, according to one embodiment of the invention, the first object 411 may perform an action of breaking a specific object 421 on the basis of interactive data of the first user 401 (e.g., swinging a first) acquired with respect to a branch of a second unit content 420 of the interactive content 400 in which the first user 401 participates, and the specific object 431 may be provided in a broken state in a third unit content 430 that is provided to the first user 401 following the second unit content 420. Meanwhile, the appearance, shape, facial expression, emotion, or action of the first object 411 may be reflected in the third unit content 430 provided to the first user, on the basis of the interactive data of the first user 401 acquired with respect to the branch of the second unit content 420. For example, when the interactive data of the first user 401 acquired with respect to the branch of the second unit content 420 is data on a smiling facial expression, the first object 411 may be provided with a smiling facial expression in the third unit content 430 provided to the first user 401.

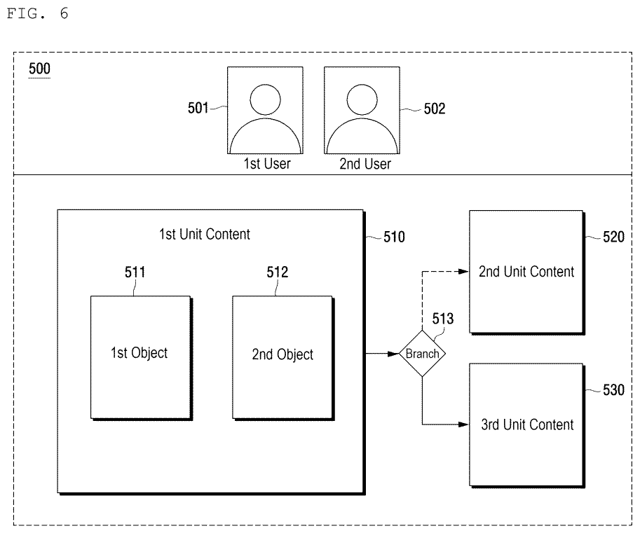

Next, referring to FIG. 5, according to one embodiment of the invention, the specific object 431 may be provided in a broken state in the third unit content 430 of the interactive content 400 in which the second user 402 participates, on the basis of the interactive data of the first user 401. (Meanwhile, when the interactive data of the first user 401 acquired with respect to the branch of the second unit content 420 is data on a smiling facial expression, the first object 411 may be provided with a smiling facial expression in the third unit content 430 provided to the second user 402.) Here, since the specific object 431 is in a broken state in the third unit content 430 of the interactive content 400 in which the second user 402 participates, the second user 402 cannot be provided with a fifth unit content 450, which is provided when a predetermined condition associated with the specific object 431 is satisfied in a branch 414 of the third unit content 430 (e.g., the first user 401 or the second user 402 performs an action of moving the specific object 431 to a specific location without breaking it), but may be provided with only a fourth unit content 440 according to the condition of the branch.

FIG. 6 illustratively shows another situation in which information on progress of an interactive content provided to a user is determined on the basis of another user's interactive data according to one embodiment of the invention.

Referring to FIG. 6, according to one embodiment of the invention, a situation may be assumed in which a first user 501 and a second user 502 participate together in the same interactive content 500 (i.e., a single interactive content) at the same time.

According to one embodiment of the invention, an action by a first object 511 and an action by a second object 512 may be determined on the basis of interactive data of the first user 501 and interactive data of the second user 502 in a branch 513 of a first unit content 510 of the interactive content 500 in which the first user 501 and the second user 502 participate, wherein the combination of the action of the first object 511 and the action of the second object 512 may satisfy a specific condition that cannot be satisfied if either the first user 501 or the second user 502 participates in the interactive content 500 alone (e.g., a condition that items respectively held by the first object 511 and the second object 512 are combined to produce a new item, which cannot be satisfied if either object is controlled as an NPC object because it is not possible to hold or combine the items). Among a plurality of unit contents (e.g., a second unit content 520 and a third unit content 530) that may be provided in the branch 513 of the first unit content 510, the third unit content 530, which is provided if the specific condition is satisfied, may be provided to the first user 501 and the second user 502.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks, and magnetic tapes; optical media such as compact disk-read only memory (CD-ROM) and digital versatile disks (DVDs); magneto-optical media such as floptical disks; and hardware devices such as read-only memory (ROM), random access memory (RAM), and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for providing interactive contents, the method comprising the steps of:
acquiring interactive data of a first user participating in an interactive content in which at least one unit content is provided according to a condition in at least one branch; and
determining information on progress of an interactive content in which a second user associated with the first user participates, with reference to the interactive data of the first user.

2. The method of claim 1, wherein the first user and the second user participate together in the same interactive content.

3. The method of claim 1, wherein at least one unit content of the interactive content in which the second user participates is provided to the first user if at least one condition is satisfied in at least one branch of the interactive content in which the first user participates, and
wherein at least one unit content of the interactive content in which the first user participates is provided to the second user if at least one condition is satisfied in at least one branch of the interactive content in which the second user participates.

4. The method of claim 1, wherein a first object among objects of the interactive content in which the first user participates is associated with the first user, and a second object among objects of the interactive content in which the second user participates is associated with the second user.

5. The method of claim 4, wherein an action of the first object is determined on the basis of the interactive data of the first user, and an action of the second object is determined on the basis of interactive data of the second user.

6. The method of claim 1, wherein the interactive data is acquired with respect to the at least one branch.

7. The method of claim 1, wherein in the determining step, the at least one branch is a plurality of branches, and the information on the progress of the interactive content in which the second user participates is determined with reference to the interactive data of the first user cumulatively acquired with respect to each of the plurality of branches.

8. The method of claim 1, wherein in the determining step, a unit content to be provided in at least one branch of the interactive content in which the second user participates is determined with reference to the interactive data of the first user.

9. The method of claim 1, wherein the information on the progress of the interactive content in which the second user participates is determined on the basis of a number of users associated with the interactive content in which the first user participates or the interactive content in which the second user participates.

10. The method of claim 5, wherein the information on the progress of the interactive content in which the second user participates is determined on the basis of a combination of the first object's action and the second object's action.

11. The method of claim 1, wherein an object not associated with a specific user, among objects of the interactive content in which the first user participates or the interactive content in which the second user participates, is controlled as a non-player character (NPC) object.

12. A non-transitory computer-readable recording medium having stored thereon a computer program for executing the method of claim 1.

13. A system for providing interactive contents, the system comprising:
a data acquisition unit configured to acquire interactive data of a first user participating in an interactive content in which at least one unit content is provided according to a condition in at least one branch; and
an information determination unit configured to determine information on progress of an interactive content in which a second user associated with the first user participates, with reference to the interactive data of the first user.
